(19) United States
(12) Patent Application Publication
(10) Pub. No.: US 2009/0026855 A1
(43) Pub. Date: Jan. 29, 2009

(54) MOTOR PROVIDED WITH HOLDING STRUCTURE FOR RADIAL BEARING

(75) Inventor: Shigeru Kasai, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/180,925

(22) Filed: Jul. 28, 2008

(30) Foreign Application Priority Data
Jul. 26, 2007 (JP) 2007-194108

(51) Int. Cl. H02K 15/14

(52) U.S. Cl. 310/42

(57) ABSTRACT

A motor may include a rotor having a rotation shaft, a stator, a first radial bearing and a second radial bearing which rotatably support the rotation shaft. The motor may further include a second plate which is fixed to the end face of the stator and is formed with a second bearing insertion opening into which the second radial bearing is inserted. The second bearing insertion opening is formed with a bearing abutting part which abuts with an outer peripheral face of the second radial bearing to restrict movement in a radial direction of the second radial bearing, and a cut-out part which is radially recessed from an inner circumferential edge of the bearing abutting part for reducing an abutting area of the second radial bearing with the second bearing insertion opening.

### CROSS REFERENCE TO RELATED APPLICATION

The present invention claims priority under 35 U.S.C. §119 to Japanese Application No. 2007-194108 filed Jul. 26, 2007, the entire contents of which are incorporated herein by reference.

### FIELD OF THE INVENTION

At least an embodiment of the present invention may relate to a motor. More specifically, at least an embodiment of the present invention may relate to a holding structure for a bearing which supports a rotation shaft of a motor.

### BACKGROUND OF THE INVENTION

Motors have been known which are used as a drive source for a digital camera, a digital video camera, an optical disk drive (ODD) and the like. As an example of the motor, a motor whose rotation shaft is supported by two radial bearings is described in Japanese Patent Laid-Open No. Hei 6-178526.

Concentricity of the two radial bearings is one of important factors which determine quality of the motor. When the concentricity is deteriorated, axis run-out of the rotation shaft occurs and thus noise and vibration during driving become larger. Therefore, the radial bearings are preferably mounted by press fitting to a bearing support hole of a side plate for holding the bearing.

However, when a press-fitting margin is set between the bearing support hole and the radial bearing, a dimension of an inner diameter of the bearing hole into which the rotation shaft of the motor is inserted may be varied or the bearing hole may be deformed due to a pressure which is applied to an outer peripheral face of the radial bearing.

In order to prevent this problem, it is conceivable that a clearance between the bearing hole and the rotation shaft is set by previous consideration of variation of the dimension of the inner diameter of the bearing hole. However, when an estimated variation of the inner diameter dimension does not occur, rattling due to a clearance between the rotation shaft and the radial bearing becomes larger and, as a result, the axis run-out of the rotation shaft, the noise and vibration during motor driving are deteriorated.

### SUMMARY OF THE INVENTION

In view of the problems described above, at least an embodiment of the present invention may advantageously provide a motor which is capable of preventing axis run-out or the like of a rotation shaft with a simple structure and is capable of reducing noise, vibration or the like during driving of the motor.

Thus, according to at least an embodiment of the present invention, there may be provided a motor including a rotor having a rotation shaft and a permanent magnet on an outer peripheral side of the rotation shaft, a stator which is disposed on an outer peripheral side of the rotor and is provided with a stator core formed with a rotor insertion hole into which the rotor is inserted, a first radial bearing and a second radial bearing which rotatably support the rotation shaft, a first plate which is fixed to one of end faces of the stator and is formed with a first bearing insertion opening into which the first radial bearing is inserted, and a second plate which is fixed to the other of the end faces of the stator and is formed with a second bearing insertion opening into which the second radial bearing is inserted. The second bearing insertion opening is formed with a bearing abutting part, which abuts with an outer peripheral face of the second radial bearing to restrict movement in a radial direction of the second radial bearing, and a cut-out part which is radially recessed from an inner circumferential edge of the bearing abutting part for reducing an abutting area of the second radial bearing with the second bearing insertion opening.

As described above, the cut-out part is formed on the inner circumferential edge of the bearing abutting part of the second radial bearing to reduce the abutting area of the second radial bearing with the second bearing insertion opening. Therefore, the dimension of the inner diameter of the second radial bearing into which the rotation shaft is inserted does not vary. Accordingly, designing can be performed without considering variation of the dimension of the inner diameter of the second radial bearing, an appropriate press-fitting margin can be set between the second radial bearing and the second bearing insertion opening and thus a high degree of concentricity of the first radial bearing with the second radial bearing can be secured. In addition, since the inner diameter dimension of the second radial bearing is not varied, a clearance between the rotation shaft and the second radial bearing can be set smaller. Therefore, variation of the dimension of the inner diameter of the second radial bearing is restrained and the axis run-out of the rotation shaft during motor driving is prevented and a motor with low noise, less vibration and low torque loss can be attained.

In this case, it is preferable that the cut-out part is formed at a plurality of positions along the inner circumferential edge of the bearing abutting part. According to this structure, the abutting area of the second radial bearing with the second bearing insertion opening into which the second radial bearing is inserted is reduced and thus the radial bearing can be smoothly inserted into the bearing insertion opening and the second radial bearing can be held with the second bearing insertion opening in a stable state.

Further, it is preferable that the second radial bearing is provided with a flange part which is protruded in a ring shape from its periphery. According to this structure, the flange part abuts with a peripheral end face of the second bearing insertion opening of the second plate and thus the second radial bearing is held by the second plate. Further, positioning in an axial line direction of the second radial bearing becomes easy.

Further, it is preferable that an inner diameter of the bearing abutting part is set to be equal to a diameter of the rotor insertion hole. According to this structure, the bearing abutting part does not protrude on the inner side (rotation shaft side) from the rotor insertion hole. Therefore, for example, when the second radial bearing is fitted into the bearing insertion opening, a force applied to the second plate is received with the stator and thus deformation of the second plate due to the above-mentioned force, in other words, deformation of the bearing abutting part can be prevented. In addition, the diameter of the bearing abutting part is set to be equal to that of the rotor insertion hole and thus the concentricity of the second radial bearing with respect to the stator can be secured easily.

Further, it is preferable that a cover member having a bottom part formed in a bottomed shape for holding the second radial bearing is attached to the second plate, and an end face on an opposite-to-output side of the rotation shaft is supported by the bottom part of the cover member. According to this structure, falling of the second radial bearing can be prevented by the cover member and a thrust load applied to the rotation shaft in the opposite-to-output direction can be supported.

Further, it is preferable that the second radial bearing is an oil-impregnated sintered bearing, and lubricating oil exuded from the oil-impregnated sintered bearing is preserved in a recessed part which is formed in the cover member. According to this structure, outflow of the exuded lubricating oil from the second radial bearing to the outside is prevented and a satisfactory sliding property of the rotation shaft can be maintained for a long term.

Further, it is preferable that a gap space is formed between an end face of the second radial bearing and the bottom part of the cover member, and a length in an axial line direction of the gap space is shorter than a length in the axial line direction of the second bearing insertion opening. According to this structure, even when the second radial bearing is moved on the opposite-to-output side due to, for example, an unanticipated strong impact, the second radial bearing is held by the bottom part of the cover member without falling of the second radial bearing from the second bearing insertion opening and without deteriorating of radial bearing function.

In addition, it is preferable that the first bearing insertion opening is formed with a bearing abutting part which abuts with an outer peripheral face of the first radial bearing to restrict movement in a radial direction of the first radial bearing, and a cut-out part which is radially recessed from an inner circumferential edge of the bearing abutting part for reducing an abutting area of the first radial bearing with the first bearing insertion opening. More preferably, the cut-out part is formed at a plurality of positions along the inner circumferential edge of the bearing abutting part. According to this structure, a press-fitting margin can be set between the first radial bearing and the first bearing insertion opening and thus a high degree of concentricity of the first radial bearing with the second radial bearing can be secured

Further, it is preferable that the first radial bearing is provided with a flange part which is protruded in a ring shape from its periphery. According to this structure, similarly to the second radial bearing, the flange part abuts with a peripheral end face of the first bearing insertion opening of the first plate and thus the first radial bearing is held by the first plate. Further, positioning in an axial line direction of the first radial bearing becomes easy.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view showing a motor in accordance with an embodiment of the present invention.

FIG. 2 is a perspective outward appearance view showing a second plate which is provided in the motor shown in FIG. 1.

FIG. 3 is a perspective outward appearance view showing a concentric jig which is used in assembling steps for the motor shown in FIG. 1.

FIG. 4 is a schematic view for explaining a first step in the assembling steps for the motor shown in FIG. 1.

FIG. 5 is a schematic view for explaining a second step in the assembling steps for the motor shown in FIG. 1.

FIG. 6 is a schematic view for explaining a third step in the assembling steps for the motor shown in FIG. 1.

FIG. 7 is a schematic view for explaining a fourth step and a fifth step in the assembling steps for the motor shown in FIG. 1.

### DETAILED DESCRIPTION OF THE PREFERRED EMBODIMENTS

An embodiment of a motor in accordance with an embodiment of the present invention will be described in detail below with reference to the accompanying drawings.

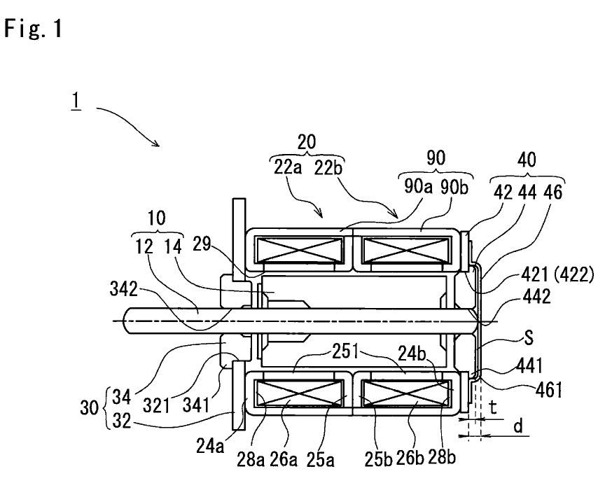

FIG. 1 is a cross-sectional view showing a motor 1 in accordance with an embodiment of the present invention. The motor 1 in this embodiment includes a rotor 10, a stator 20, a first bearing part 30 and a second bearing part 40. The first bearing part 30 includes a first radial bearing 34 for rotatably supporting the rotor 10 on an output side of the motor 1 and a first plate 32 which is fixed to an end face on an output side of the stator 20 for mounting the first radial bearing 34. The second bearing part 40 includes a second radial bearing 44 for rotatably supporting the rotor 10 on an opposite-to-output side of the motor 1 and a second plate 42 which is fixed to an end face on an opposite-to-output side of the stator 20 for mounting the second radial bearing 44.

The rotor 10 is provided with a rotation shaft 12 and a permanent magnet 14. Specifically, an output side of the rotation shaft 12 is protruded from the stator 20. Further, the permanent magnet 14 is fixed to an outer peripheral face on the opposite-to-output side of the rotation shaft 12. The permanent magnet 14 is alternately magnetized with an “N”-pole and an “S”-pole in its circumferential direction.

The stator 20 is structured of two stator assemblies 22a and 22b which are disposed at positions facing an outer peripheral face of the permanent magnet 14 and superposed on each other in an axial direction. Each of the two stator assemblies 22a and 22b includes outer stator cores 24a and 24b, coil bobbins 28a and 28b around which drive coils 26a and 26b are wound, and inner stator cores 25a and 25b sandwiching the coil bobbins 28a and 28b with the outer stator cores 24a and 24b. The outer stator cores 24a and 24b and the inner stator cores 25a and 25b are respectively formed with a rotor insertion hole 29, which is provided with a diameter larger than an outer diameter of the rotor 10 (permanent magnet 14) at its center portion for inserting the rotor 10 (permanent magnet 14), and a plurality of pole teeth 251 which are formed so as to face the outer periphery of the permanent magnet 14. The pole teeth 251 are formed so as to be perpendicularly bent in an axial direction from an inner circumferential edge of the rotor insertion hole 29 which is formed in each of the outer stator cores 24a and 24b and the inner stator cores 25a and 25b. The pole teeth 251 are formed in a circular ring shape with a substantially equal interval. In addition, the respective pole teeth 251 formed in the outer stator core 24a and the inner stator core 25a are alternately disposed so as to face the outer periphery of the permanent magnet 14. Similarly, the respective pole teeth 251 formed in the outer stator core 24b and the inner stator core 25b are also alternately disposed so as to face the outer periphery of the permanent magnet 14.

Further, outer peripheral portions of the outer stator cores 24a and 24b are bent toward in the axial direction so as to cover the outer peripheries of the drive coils 26a and 26b. The portions of the outer stator cores 24a and 24b covering the outer peripheries of the drive coils 26a and 26b function as a motor case 90. In this embodiment, the motor case 90 is structured of a first case part 90a which is formed in the outer stator core 24a to cover the outer periphery of the drive coil 26a and a second case part 90b which is formed in the outer stator core 24b to cover the outer periphery of the drive coil 26b.

The first bearing part 30 is structured of a first plate 32 and a first radial bearing 34. The first plate 32 is a metal plate member which is formed at its center portion with a first bearing insertion opening 321 that is a through hole into which the first radial bearing 34 is inserted. The first plate 32 is fixed to an end face on the output side of the stator 20 (outer stator core 24a) by welding or the like.

The first radial bearing 34 is a radial bearing which is formed in a cylindrical shape and is provided with a flange part 341 circumferentially protruding from a periphery of an end face on its one side. The first radial bearing 34 is mounted on the first bearing insertion opening 321 of the first plate 32. The flange part 341 engages with a peripheral portion of the first bearing insertion opening 321 at the time of mounting of the first radial bearing 34 and serves as a positioning part in the axial direction of the first radial bearing 34. Further, the rotation shaft 12 is rotatably supported by a bearing hole 342 of the first radial bearing 34.

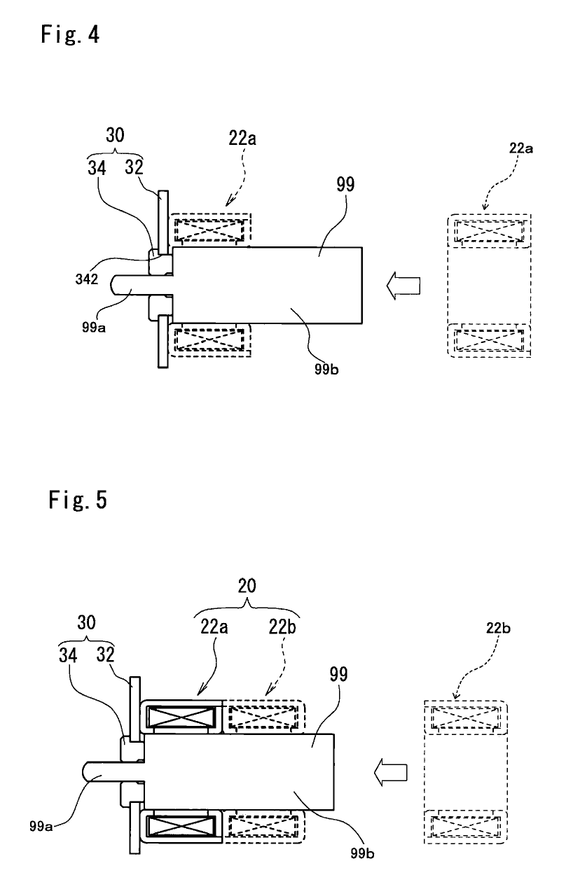

The first radial bearing 34 is press-fitted and fixed to the first bearing insertion opening 321. In this embodiment, when a large force is applied to a cylindrical outer peripheral face of the first radial bearing 34, an inner diameter dimension of the bearing hole 342 may be affected and varied and thus it is preferable that the first radial bearing 34 is press-fitted and fixed to the first bearing insertion opening 321 to such an extent that an inner peripheral face of the bearing hole 342 is not deformed. In addition, in this embodiment, as shown in FIG. 4, in the assembling steps, the first radial bearing 34 is mounted on the first bearing insertion opening 321 of the first plate 32 to structure the first bearing part 30. Therefore, a portion on an opposite side in the axial direction to the flange part 341 may be caulked and thus, even when the first radial bearing 34 is not press-fitted with a strong force, the first radial bearing 34 can be fixed to the first plate 32.

The second bearing part 40 is structured of a second plate 42, a second radial bearing 44 and a cover member 46. The second plate 42 is a metal plate member which is formed at a center portion with a second bearing insertion opening 421 that is a through hole for inserting the second radial bearing 44. The second plate 42 is fixed to an end face on an opposite-to-output side of the stator 20 (outer stator core 24b) by welding or the like. Further, in this embodiment, an inner diameter of the second bearing insertion opening 421 is set to be equal to the inner diameter of the rotor insertion hole 29 formed in the stator 20. Specifically, the diameter of the second bearing insertion opening 421 is equal to the diameter of the rotor insertion hole 29, i.e., the inner peripheral faces of the pole teeth 251 of the respective outer stator cores 24a, 24b and the inner stator cores 25a, 25b; those are the reference. Therefore, the outer peripheral face of the second radial bearing 44 can be inserted into the rotor insertion hole 29 without contacting with the pole teeth 251 of the outer stator core 24b. In addition, different from an assembling method as described below with reference to FIGS. 4 through 7, even when the rotor 10 is inserted after the second bearing part 40 has been fixed to the stator 20, the rotor 10 can be disposed at a predetermined position without contacting of the outer peripheral face of the permanent magnet 14 with the pole teeth 251 and the second bearing insertion opening 421.

The second radial bearing 44 is a radial bearing which is formed in a cylindrical shape and is provided with a flange part 441 circumferentially protruding from a periphery of an end face on its one side. The second radial bearing 44 is mounted on the second bearing insertion opening 421 of the second plate 42 by press-fitting. In this embodiment, the second radial bearing 44 is an oil-impregnated sintered bearing, i.e., a bearing which utilizes porous that is a feature of sintered material and which is used in a self lubrication state where lubricating oil is impregnated into pores. The flange part 441 engages with a peripheral portion of the second bearing insertion opening 421 at the time of mounting of the second radial bearing 44 and serves as a positioning part in the axial direction of the second radial bearing 44. Further, an opposite-to-output side of the rotation shaft 12 is rotatably supported by a bearing hole 442 of the second radial bearing 44.

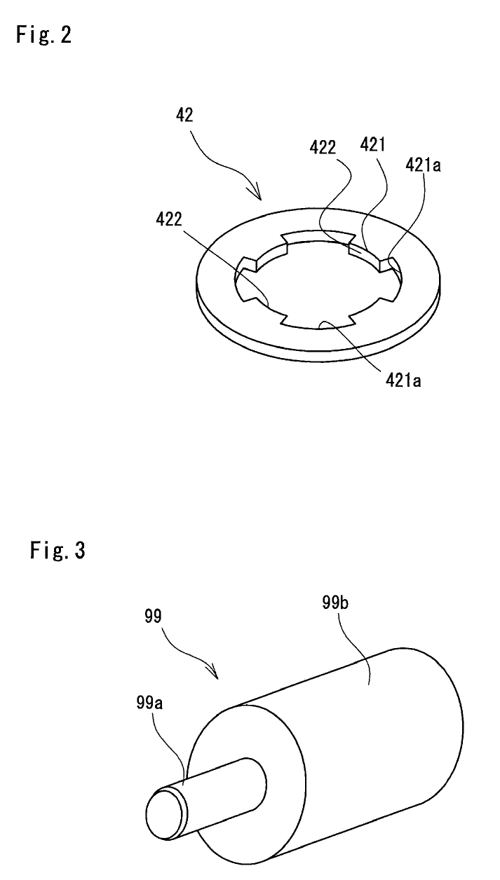

Next, a shape of the second bearing insertion opening 421 formed in the second plate 42 will be described below. FIG. 2 is a perspective outward appearance view showing the second plate 42. As shown in FIG. 2, the second bearing insertion opening 421 is formed with a plurality of bearing abutting parts 422, which abut with the outer peripheral face of the second radial bearing 44 to restrict movement in the radial direction of the second radial bearing 44, and a plurality of cut-out parts 421a which are recessed in the radial direction from the inner circumferential edge of the bearing abutting part 422. In this embodiment, the cut-out parts 421a are formed at four positions with an equal interval and all the cut-out parts 421a do not contact with the outer peripheral face of the second radial bearing 44. Therefore, an abutting area (size of the bearing abutting part 422) of the second bearing insertion opening 421 with the second radial bearing 44 can be reduced by forming with the cut-out parts 421a in comparison with a conventional structure that the whole circumference of the inner circumferential edge of the bearing insertion opening is abutted with the outer periphery of the radial bearing. As a result, even when the second radial bearing 44 is fitted into the second bearing insertion opening 421 by press-fitting, an excessive pressure is not applied to the outer peripheral face of the second radial bearing 44 and thus deformation of the bearing hole 442 is prevented.

According to the motor 1 in this embodiment, deformation of the bearing hole 442 is prevented when the second radial bearing 44 is mounted on the second plate 42. Therefore, a predetermined press-fitting margin can be set between the outer peripheral face of the second radial bearing 44 and the second bearing insertion opening 421 and thus a high degree of concentricity of the first radial bearing 34 with the second radial bearing 44 is secured. In addition, since deformation of the bearing hole 442 is prevented, a clearance between the rotation shaft 12 and the bearing hole 442 can be set small. Therefore, the axis run-out of the rotation shaft 12 during motor driving is prevented and the motor 1 with a low noise, a less vibration and a low torque loss can be obtained.

In addition, since a plurality of the cut-out parts 421a are formed, the area of the bearing abutting part 422 where the second radial bearing 44 is abutted with the second bearing insertion opening 421 becomes smaller and a resistance when the second radial bearing 44 is inserted into the second bearing insertion opening 421 becomes smaller and thus the second radial bearing 44 can be smoothly inserted into the second bearing insertion opening 421.

The cover member 46 is a bottomed metal plate member formed with a recessed part 461 which is recessed on the outer side in the axial direction by a press-drawing work from a portion welded and fixed to the second plate 42. The cover member 46 is fixed to the second plate 42 by welding or the like in the state where the second radial bearing 44 is accommodated in the recessed part 461. In this manner, the bottomed portion of the cover member 46 serves as a falling-off prevention member for the second radial bearing 44 which is press-fitted into the second plate 42. In addition, the end face on the opposite-to-output side of the rotation shaft 12 is positioned in an abutted state with the cover member 46 and thus, when a thrust load in the opposite-to-output direction is applied to the rotation shaft 12, the load is received by the cover member 46.

Further, a width dimension (radial direction) of the recessed part 461 is set to be slightly larger than a width dimension (radial direction) of the second radial bearing 44 including the flange part 441 and a depth “d” of the recessed part 461 over the whole width dimension is set to be larger than a thickness “t” of the flange part 441. Therefore, when the cover member 46 is fixed to the second plate 42, a gap space S is formed between the end face of the second radial bearing 44 and the bottom part of the recessed part 461. The gap space S is used to store a lubricating oil which is exuded from the second radial bearing 44 (oil-impregnated sintered bearing) when the motor 1 is driven, and the lubricating oil is prevented from being flown outside. Therefore, a satisfactory sliding property of the rotation shaft 12 can be maintained for a long term.

In addition, the gap space S which is formed between the end face of the second radial bearing 44 and the bottom face of the recessed part 461 of the cover member 46 is narrower than a length in the axial direction of the second bearing insertion opening 421 of the second plate 42 (plate thickness of the bearing abutting part 422). Therefore, even when the second radial bearing 44 is moved on the opposite-to-output side due to, for example, an unanticipated strong impact, the second radial bearing 42 is held by the bottom part of the cover member 46 without the second radial bearing 44 falling from the second bearing insertion opening 421 and thus its radial bearing function is not deteriorated. In other words, the recessed part 461 is formed as a recessed part which permits movement of the second radial bearing 44.

In the embodiment described above, the cut-out parts 421a are formed on the inner circumferential edge of the bearing abutting part 422 of the second bearing insertion opening 421. Similarly, a plurality of cut-out parts for reducing an area of an abutting portion (bearing abutting part) of the first radial bearing 34 with the first bearing insertion opening 321 may be formed along an inner circumferential edge of the first bearing insertion opening 321. As a result, concentricity of the first radial bearing 34 and the second radial bearing 44 can be further enhanced. In addition, a clearance between the bearing hole 342 of the first radial bearing 34 and the rotation shaft 12 can be set smaller and thus the axis run-out of the rotation shaft 12 during the motor driving is further restrained.

Next, an assembling method for the motor 1 in accordance with this embodiment will be described below.

In the assembling steps, a concentric jig 99 shown in FIG. 3 is used. The concentric jig 99 includes a small diameter part 99a having the same diameter as the rotation shaft 12 and a large diameter part 99b having the same diameter as the inner diameter of the stator 20. The small diameter part 99a and the large diameter part 99b are connected with each other in a state that their axial lines are coincided with each other.

First, as shown in FIG. 4, the first bearing part 30 and the stator assembly 22a will be fixed to each other by using the concentric jig 99. In other words, the small diameter part 99a of the concentric jig 99 is inserted into the bearing hole 342 of the first radial bearing 34 and the stator assembly 22a is fitted to the large diameter part 99b. In this state, the first bearing part 30 and the stator assembly 22a are fixed to each other by welding (first step).

Next, as shown in FIG. 5, the stator assembly 22b is fitted to the large diameter part 99b of the concentric jig 99. In this state, the stator assemblies 22a and 22b are fixed to each other by welding to structure the stator 20. In this manner, the stator assemblies 22a and 22b can be easily assembled in a concentric state by the concentric jig 99 (second step).

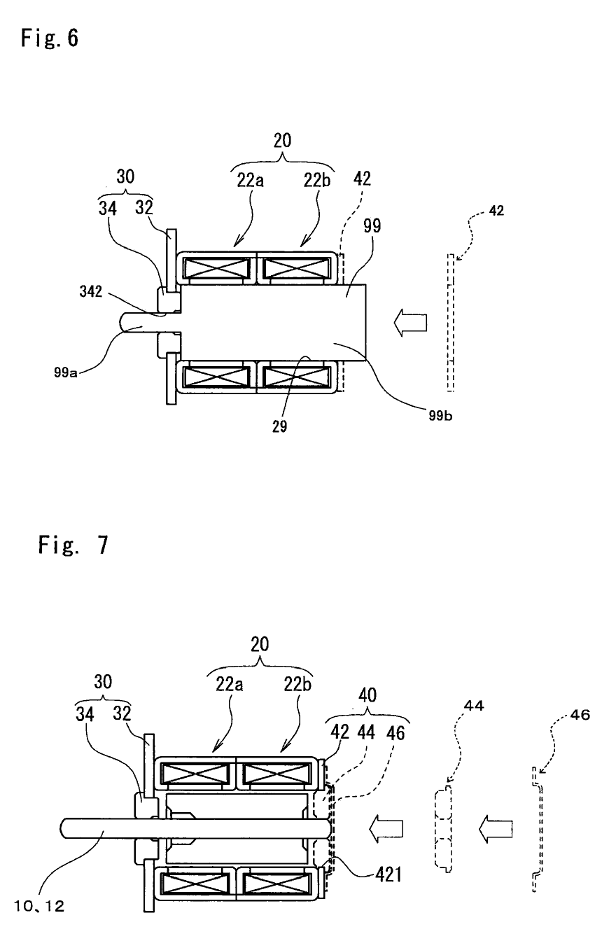

Next, as shown in FIG. 6, the second plate 42 is fitted to the large diameter part 99b of the concentric jig 99. In this case, the second plate 42 is positioned in a concentric state with the rotor insertion hole 29 and the bearing hole 342 of the first radial bearing 34 as the reference. In this state, the stator assembly 22b and the second plate 42 are fixed to each other by welding (third step).

Next, as shown in FIG. 7, the concentric jig 99 is removed and the rotor 10 is inserted into the inside of the stator 20. In this case, the rotation shaft 12 is rotatably supported by the first radial bearing 34 and thus the axis run-out of the rotor 10 is prevented. Next, the second radial bearing 44 is mounted on the second bearing insertion opening 421 (fourth step). Finally, the cover member 46 is fixed to the second plate 42 by welding (fifth step) and assembling of the motor 1 has been completed.

According to the assembling steps described above, a high degree of concentricity of the first radial bearing 34 with the second radial bearing 44 can be secured with the simple jig as described above. As a result, a high performance motor with low noise and less vibration in which the axis run-out of the rotation shaft 12 during motor driving is restrained can be easily manufactured.

As described above, according to the motor 1 in accordance with an embodiment of the present invention, the abutting area of the second radial bearing 44 with the second bearing insertion opening 421 can be made smaller by the cut-out parts 421a which are formed on the inner circumferential edge of the bearing abutting part 422 of the second bearing insertion opening 421. Therefore, a pressure occurred when the second radial bearing 44 is inserted can be appropriately deconcentrated to the second bearing insertion opening 421 and thus a variation of the inner diameter dimension of the second radial bearing 44 or deformation of the inner peripheral face of the second radial bearing 44 can be restrained. Accordingly, a press-fitting margin can be set between the second radial bearing 44 and the second bearing insertion opening 421 and thus a high degree of concentricity of the first radial bearing 34 with the second radial bearing 44 is secured. In addition, since the inner diameter dimension of the second radial bearing 44 is not varied, a clearance between the rotation shaft 12 and the second radial bearing 44 can be set smaller. As a result, the axis run-out of the rotation shaft 12 during motor driving can be prevented and the motor 1 with low noise, less vibration and low torque loss can be attained.

Further, the inner circumferential edge portion of the first bearing insertion opening 321 may be formed with the bearing abutting parts, which abut with the outer peripheral face of the first radial 34 to restrict movement in the radial direction of the bearing, and cut-out parts which are radially recessed from the bearing abutting parts for reducing the abutting area of the first radial bearing 34 with the first bearing insertion opening 321. In this case, a press-fitting margin can be set between the first radial bearing 34 and the first bearing insertion opening 321 and thus a high degree of concentricity of the first radial bearing 34 with the second radial bearing 44 can be further secured.

In addition, a plurality of the cut-out parts 421a is formed along the inner circumferential edge portions of the bearing abutting parts 422 of the second bearing insertion opening 421. Therefore, the abutting area of the second radial bearing 44 with the second bearing insertion opening 421 becomes smaller and thus the second radial bearing 44 can be smoothly inserted into the second bearing insertion opening 421 and, in addition, the second radial bearing 44 can be held with the bearing abutting parts 422 in a stable state.

Further, the flange parts 341 and 441 which are circumferentially protruded and engaged with the first plate 32 and the second plate 42 respectively are formed on peripheries of the first radial bearing 34 and the second radial bearing 44. Therefore, positioning in the axial direction of the first radial bearing 34 and the second radial bearing 44 are performed easily.

Further, the cover member 46 having the bottom part formed in a bottomed shape is mounted on the second plate 42 so as to hold the second radial bearing 44 and the end face on the opposite-to-output side of the rotation shaft 12 is supported by the bottom part of the cover member 46. Therefore, falling of the second radial bearing 44 can be prevented by the cover member 46 and a thrust load applied to the rotation shaft 12 in the opposite-to-output direction can be supported.

Further, since the second radial bearing 44 is an oil-impregnated sintered bearing, lubricating oil impregnated into pores may be exuded from the bearing by use of the motor. In this embodiment, the exuded lubricating oil is preserved in the recessed part 461 which is formed in the cover member 46 and thus outflow of the exuded lubricating oil from the second radial bearing 44 to the outside is prevented and a satisfactory sliding property of the rotation shaft 12 can be maintained for a long term.

Further, the bearing abutting parts 422 of the second plate 42 are formed in the same diameter as that of the rotor insertion hole 29 and thus the bearing abutting parts 422 do not protrude on the inner side (rotation shaft 12 side) from the rotor insertion hole 29. Therefore, for example, when the second radial bearing 44 is fitted into the second bearing insertion opening 421, a force applied to the second plate 42 is received with the stator 20 (outer stator core 24b). Accordingly, deformation of the second plate 42 due to the above-mentioned force, in other words, deformation of the bearing abutting parts 422 can be prevented. In addition, the diameter of the bearing abutting parts 422 is set to be the same diameter of the rotor insertion hole 29 and thus the concentricity of the second radial bearing 44 with respect to the stator 20 can be secured easily.

The present invention has been described in detail using the embodiments, but the present invention is not limited to the embodiments described above and many modifications can be made without departing from the present invention.

For example, in the embodiment described above, the second plate 42 is formed of a metal plate member. However, the present invention is not limited to this embodiment. Even when the second plate 42 is formed of resin by injection molding or the like, the present invention can be applicable.

Further, in the embodiment described above, four cut-out parts 421a are formed in the second plate 42 but the present invention is not limited to this embodiment. Press fitting strength can be adjusted by means of that the abutting area of the bearing abutting parts 422 abutting with the outer peripheral face of the second radial bearing 42 is increased or decreased. Alternatively, the number of the cut-out parts 421a may be increased or decreased, or the not-abutting area by the cut-out parts 421a may be increased or decreased.

A motor in accordance with the present invention may be used as an actuator for an OA device or an AV device such as a digital camera, a digital video camera or an optical disk drive (ODD).

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor comprising a rotation shaft and a permanent magnet on an outer peripheral side of the rotation shaft;
a stator which is disposed on an outer peripheral side of the rotor and is provided with a stator core formed with a rotor insertion hole into which the rotor is inserted;
a first radial bearing and a second radial bearing which rotatably support the rotation shaft;
a first plate which is fixed to one of end faces of the stator and is formed with a first bearing insertion opening into which the first radial bearing is inserted; and
a second plate which is fixed to the other of the end faces of the stator and is formed with a second bearing insertion opening into which the second radial bearing is inserted;
wherein the second bearing insertion opening is formed with:
a bearing abutting part which abuts with an outer peripheral face of the second radial bearing to restrict movement in a radial direction of the second radial bearing; and
a cut-out part which is radially recessed from an inner circumferential edge of the bearing abutting part for reducing an abutting area of the second radial bearing with the second bearing insertion opening.

2. The motor according to claim 1, wherein the cut-out part is formed at a plurality of positions along the inner circumferential edge of the bearing abutting part.

3. The motor according to claim 2, wherein the second radial bearing is provided with a flange part which is protruded in a ring shape from a periphery of the second radial bearing.

4. The motor according to claim 1, wherein an inner diameter of the bearing abutting part is set to be equal to a diameter of the rotor insertion hole.

5. The motor according to claim 1, further comprising a cover member which is formed with a bottom part formed in a bottomed shape for holding the second radial bearing and which is attached to the second plate,
wherein an end face on an opposite-to-output side of the rotation shaft is supported by the bottom part of the cover member.

6. The motor according to claim 5, wherein the second radial bearing is an oil-impregnated sintered bearing, and lubricating oil exuded from the oil-impregnated sintered bearing is preserved in a recessed part which is formed in the cover member.

7. The motor according to claim 5, wherein a gap space is formed between an end face of the second radial bearing and the bottom part of the cover member, and a length in an axial line direction of the gap space is shorter than a length in the axial line direction of the second bearing insertion opening.

8. The motor according to claim 1, wherein the first bearing insertion opening is formed with:
a bearing abutting part which abuts with an outer peripheral face of the first radial bearing to restrict movement in a radial direction of the first radial bearing; and
a cut-out part which is radially recessed from an inner circumferential edge of the bearing abutting part for reducing an abutting area of the first radial bearing with the first bearing insertion opening.

9. The motor according to claim 8, wherein the cut-out part is formed at a plurality of positions along the inner circumferential edge of the bearing abutting part.

10. The motor according to claim 9, wherein the first radial bearing is provided with a flange part which is protruded in a ring shape from a periphery of the first radial bearing.
